(19) United States
(12) Patent Application Publication
(10) Pub. No.: US 2016/0377213 A1
(43) Pub. Date: Dec. 29, 2016

(54) FUSION PIPE STRENGTHENING COLLAR

(71) Applicant: Watts Water Technologies, Inc., North Andover, MA (US)

(72) Inventors: Paul Lake, Waltham, MA (US); Stephen Barrett, Danvers, MA (US); Steven Castrigno, Manchester, NH (US)

(21) Appl. No.: 15/191,057

(22) Filed: Jun. 23, 2016

Related U.S. Application Data
(60) Provisional application No. 62/184,945, filed on Jun. 26, 2015.

(51) Int. Cl. F16L 47/03

(52) U.S. Cl. CPC F16L 47/03

(57) ABSTRACT

A fusion pipe assembly includes a fitting having at least one open end with a fusion region. A fusion pipe has a proximal end with a fusion region so that when the proximal end is inserted into the at least one open end, the fusion regions can be fused together. The fusion pipe has a distal end for mechanically coupling in a pipe network. A collar is inserted in the distal end and has an outer diameter approximately equal to an inner diameter of the distal end so that the collar strengthens the distal end. Preferably, the collar extends into the at least one open end of the fitting.

### CROSS-REFERENCE TO RELATED APPLICATION

This application claims priority to U.S. Provisional Patent Application No. 62/184,945, filed Jun. 26, 2015, which is incorporated herein by reference.

### BACKGROUND OF THE DISCLOSURE

1. Field of the Disclosure

The subject disclosure relates to systems and methods for creating pipe networks in the field, and more particularly to collars and methods for effectively joining thermo-plastic pipes quickly, efficiently and effectively.

2. Background of the Related Art

Historically, copper piping was the dominant type of system used in potable residential systems in new construction. In the last 40 years, the number of plastic pipe installations has been steadily increasing to above 80% of the systems. However, plastic pipe systems do present challenges. Often, the plastic is resistant to solvents so that joining by cementing is not effective. Typical connections are mechanical. However, heat fusion of connections is gaining popularity. For example, electro-fusion is a popular type of heat fusion as shown by U.S. PG Publication Nos.: 2006/0197338 A1; 2009/0314770 A1; and 2010/0072742 as well as U.S. Pat. Nos.: 3,378,672; 3,465,126; 3,506,519; 6,450,544; 6,250,686; and 7,984,738.

While the electro-fusion method has appeal, it has not been without its problems as there are many subtleties that can result in problems in joining plastic pipes such as polypropylene and polyvinylidene fluoride by electro-fusion. Additionally, subtleties in joint design, coupled with inadequate joining, can lead to failures occurring in service after prolonged periods of time. For this reason, many projects have suffered through severe installation difficulties, while others have seen after installation failures occur due to mechanical and other breakdowns. Generally, contractors tend to prefer the labor savings and ease of joining offered by mechanical joining methods, whereas engineers and code officials tend to prefer the use of fused joints. Matters are often further complicated by areas that are inaccessible, such as behind walls and in underground locations. Fused joints are viewed as having less likelihood of leaks over time. Conversely, mechanical joint methods are viewed as having a distinct possibility of loosening over time, whereby leaks could occur. As a result, mechanical joints are disfavored and preferably limited to instances where there is access to repair the joints, if needed.

In prior art electro-fusion methods, the methods involve applying heat and compression to the joints, requiring long set up time with external clamps. Further, the clamping force required is difficult to quantify so variability in effectiveness of the joints often occurs since there are many human elements involved in the joining processes. Even further, the clamping force can distort or damage the pipes, which leads to ineffective joints. With less than satisfactory results, a high rate of leaks and generally poor performance are encountered. As would be appreciated, as the size of the project increases, the additional labor required for clamping and attending to the fusion process can become undesirable.

Another disadvantage in prior art electro-fusion systems is that such systems require specialized configuration of the piping. The additional time, tools, parts and skill required to create such items as a female threaded pipe end creates further expense, delay, difficulty and opportunity for human error to be introduced. To address many of these shortcomings, Watts Water Technologies, Inc. of North Andover, MA has developed several technologies such as shown in US PG Pub. No. 2014/0326410 published on Nov. 6, 2014.

For example, the difficulties above are complicated by the need to transition from a T-fitting to a pipe thread end. The pipe threads may be female pipe threads (FPT) or male pipe threads (MPT). Referring now to FIG. 5, an adapter fitting 300 to transition from a T-fitting to a threaded end is shown. Common pipe diameters are 20 to 50 mm but any size is possible. The adapter fitting 300 has a threaded pipe end 302 and a coupling end 304. The adapter fitting 300 is fabricated from a material suitable for heat fusion and includes an indicator feature 306 for notification of complete fusion.

Referring now to FIGS. 6 and 7, the adapter fitting 300 is shown connected to a T-fitting 320 in plan and cross-sectional views. The T-fitting 320 has three ends 324 and also includes indicator features 322. A short pipe length 340 extends between the adapter fitting 300 and the T-fitting 320. The ends 342 of the pipe length 340 abut shoulders 308, 326 formed inside the fitting adapter 300 and T-fitting 320, respectively. The ends 342 are fused to the fitting adapter 300 and T-fitting 320 in fusion regions 344 to form a permanent unit. Since the adapter fitting 300, the T-fitting 320 and the pipe length 340 are fabricated from fusible material, the particular construction shown is required to provide the necessary structural rigidity.

### SUMMARY OF THE INVENTION

In view of the above, there is a need for improved assemblies and methods for creating pipe networks including transitioning from pipes of one diameter to another diameter. The subject technology is preferably provided as a kit, which contains a portable fusion device for fusing and the necessary components. The portable fusion device and components can be quickly and easily used to create reliable, consistent, high quality pipe joints by technicians with minimal training. The subject technology has universal application including installations of geothermal systems, irrigation systems, natural gas systems, potable systems that are typically of three or four inches in diameter, and non-potable systems.

In one embodiment, the subject technology is directed to a fusion pipe assembly including a fusion pipe having: a fusion end with a fusion region; and a threaded end with outer pipe threads. A collar has an outer diameter approximately equal to an inner diameter of the threaded end and is inserted in the threaded end so that the collar strengthens the threaded end. The fusion pipe tapers from the fusion end to the threaded end and the fusion pipe is fabricated completely from fusible material. An outer end of the collar forms a curved flange that abuts a tip of the threaded end to prevent the collar from passing too far into the fusion pipe. Alternatively, the fusion pipe forms an inner shoulder near the threaded end, and an inner end of the collar abuts the inner shoulder to prevent the collar from passing too far into the fusion pipe.

Another embodiment of the subject technology is directed to a fusion pipe assembly including a fitting having at least one open end with a fusion region. A fusion pipe has a proximal end with a fusion region so that when the proximal end is inserted into the at least one open end, the fusion regions can be fused together. The fusion pipe has a distal end for mechanically coupling in a pipe network. A collar is inserted in the distal end and has an outer diameter approximately equal to an inner diameter of the distal end so that the collar strengthens the distal end. Preferably, the collar extends into the at least one open end of the fitting. The fitting may be a T-fitting, elbow or any other fitting now known and later developed.

Still another embodiment of the subject technology is directed to a kit having a plurality of fittings, a plurality of fusion pipes, a plurality of collars for strengthening the fusion pipes, and a container for housing the fittings, fusions pipes, and collars. Each fitting has at least one open end with a fusion region for coupling to a proximal end of the pipes. The distal end of the pipes is preferably suited for mechanical coupling in a pipe network. A collar is inserted in the distal ends of the pipes. Each collar has an outer diameter approximately equal to a respective inner diameter of the distal end so that the collar strengthens the distal end of the pipe. The fusion pipes, and the collars are different types, sizes and lengths. Preferably, the fusion pipes are fabricated from fusible material and the collars are fabricated from metal to provide structural support to the fusion pipes.

It should be appreciated that the present technology can be implemented and utilized in numerous ways, including without limitation as a process, an apparatus, a system, a device, a method for applications now known and later developed. These and other unique features of the technology disclosed herein will become more readily apparent from the following description and the accompanying drawings.

### BRIEF DESCRIPTION OF THE DRAWINGS

So that those having ordinary skill in the art to which the disclosed technology appertains will more readily understand how to make and use the same, reference may be had to the following drawings.

FIG. 1 is a perspective view of a fusion pipe with strengthening collar in accordance with the subject disclosure.

FIG. 2 is a front view of the fusion pipe of FIG. 1 coupled to a T-fitting in accordance with the subject disclosure.

FIG. 3 is a cross-sectional view of the assembly of FIG. 2 taken along line 3-3 of FIG. 2.

FIG. 4 is a detailed view of the fusion pipe of FIG. 3 taken within circle 4 of FIG. 3.

FIG. 5 is a perspective view of a prior art adapter fitting assembly.

FIG. 6 is a plan view of the prior art adapter fitting assembly of FIG. 5.

FIG. 7 is a cross-sectional view of the prior art adapter fitting assembly of FIG. 5 taken along line 7-7 of FIG. 6.

### DETAILED DESCRIPTION OF PREFERRED EMBODIMENTS

The present disclosure overcomes many of the prior art problems associated with creating pipe networks including changing diameters of electro-fusion plastic pipes, transitioning from a T-fitting to a threaded end, and the like. The advantages, and other features of the systems, methods and kits disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

All relative descriptions herein such as left, right, up, down, horizontal, and vertical are with reference to the Figures, and not meant in a limiting sense. The illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology.

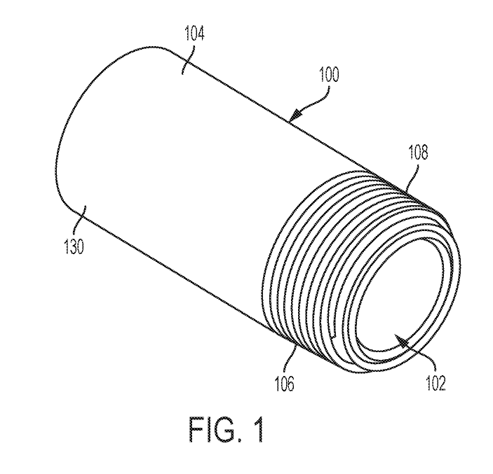

Referring now to FIG. 1, a perspective view of a fusion pipe 100 with strengthening collar 102 in accordance with the subject disclosure is shown. The fusion pipe 100 is fabricated from a fusible material. Thus, a first or plain end 104 of the pipe 100 is fusible directly to a coupling (not shown). The opposing second or threaded end 106 has outer pipe threads 108 for mechanical connection to another coupling (not shown). As shown, the outer pipe threads 108 are male pipe threads (MPT). The fusion pipe 100 can be any length or diameter depending upon the application. Preferably, the fusion pipe 100 can be provided in a longer length so that when a shorter length is desired, the fusion pipe 100 can simply be cut to the desired length in the field. The fusion pipe 100 may taper slightly from the plain end 104 to the threaded end 106 or be a uniform diameter. The strengthening collar 102 is fabricated from metal to provide structural support the fusion pipe 100.

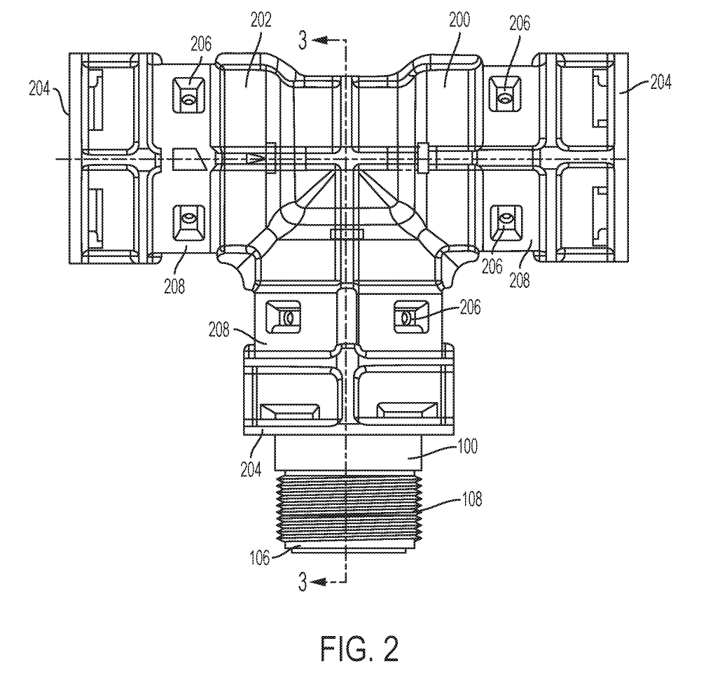

Referring now to FIG. 2, a front view of the fusion pipe 100 of FIG. 1 coupled to an exemplary T-fitting 200 is shown. The T-fitting 200 is similar to the couplings as shown in U.S. PG Pub. No. 2014/0326410 published on Nov. 6, 2014. The T-fitting 200 has a main body 202 with three similar ends 204. The T-fitting 200 also includes indicator features 206 in fusion regions 208 so that the user has audial and/or visual confirmation when fusion has successfully been completed.

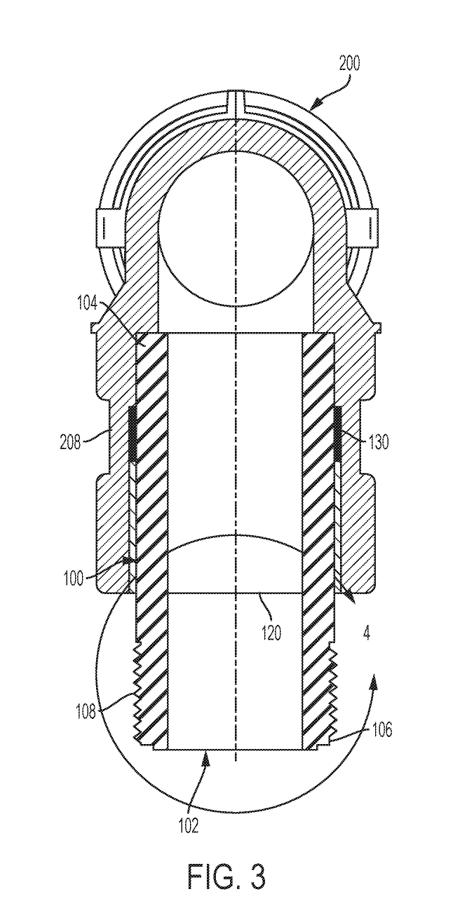

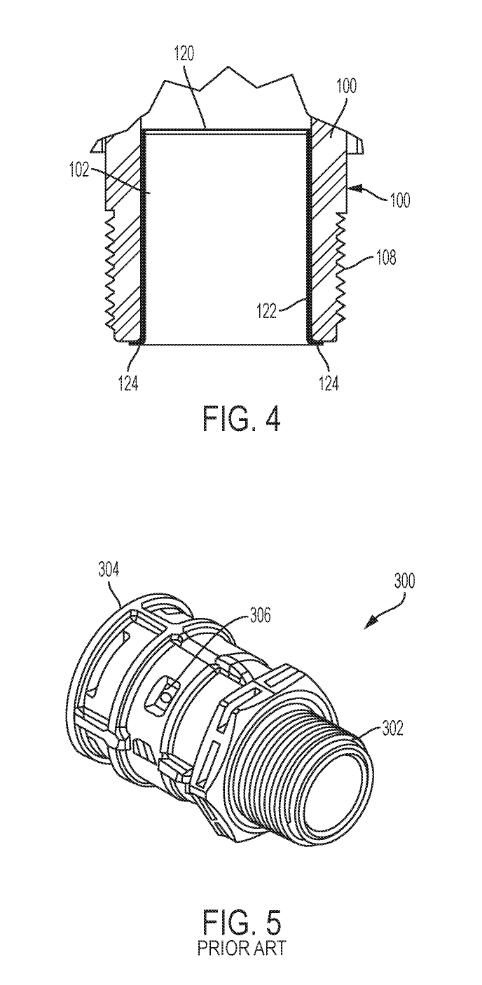

Referring now to FIGS. 3 and 4, a cross-sectional view of FIG. 2 taken along line 3-3 and a detailed view of FIG. 3 taken within circle 4 are shown, respectively. The strengthening collar 102 has a first or plain end 120 and opposing curved end 122. The plain end 120 has an outer diameter approximately equal to the inner diameter of the coupling end 204 for a snug fit. The collar 102 may also snap fit, be glued or otherwise fixedly coupled to the fusion pipe 100. The collar 102 may also move freely in and out of the fusion pipe 100.

The curved end 122 forms a flange or outward turned lip 124 that abuts the very end or tip of the threaded end 106 to prevent the strengthening collar 102 from passing too far into the fusion pipe 100. Preferably, the plain end 120 passes slightly into the T-fitting 200 but such arrangement is not necessary. In one embodiment, the first end 120 abuts a shoulder formed on the inner diameter of the fusion pipe 100 to prevent the strengthening collar 102 from passing too far into the fusion pipe 100. In another embodiment, both the shoulder and the curved end 122 are present.

When assembled with the T-fitting 200, the fusion pipe 100 has a fusion area 130 joined to the fusion region 208 of the T-fitting 200. The strengthening collar 102 fully supports the exposed threaded end 106 so that even though fabricated from fusible material, the threaded end 106 has ample structural rigidity and strength for effective and reliable mechanical coupling.

The subject technology also can be provided as a kit. The kit would include a container for housing various fittings such as T-fitting, elbows, Y-connectors, diameter adjusting sections, and the like. The kit would also include a plurality of fusion pipes with collars as described above in various sizes and lengths. Thus, any arrangement as required by the design of the pipe network can be quickly and easily formed.

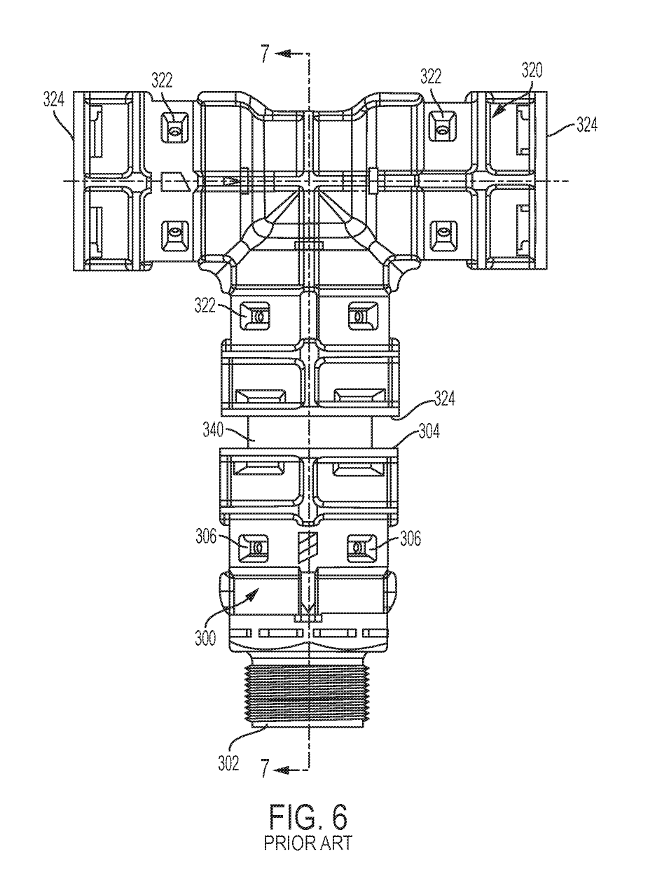

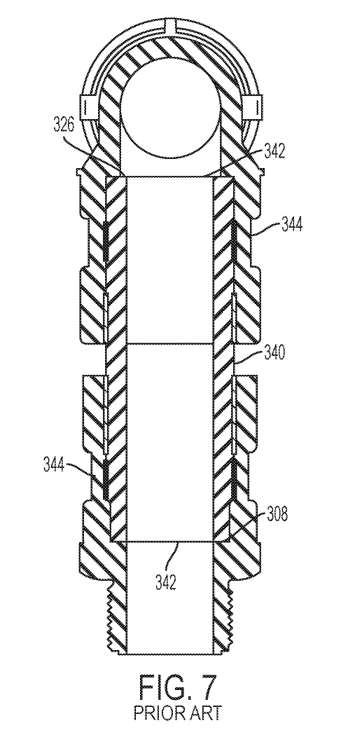

As can be seen, the subject technology provides a valuable kit that creates effective seals between pipes and couplings in a fast, easy and effective manner. In comparison to the assembly of FIG. 6, the subject technology reduces the need for one fitting and 1 additional weld. The subject technology is aslo relatively safe compared to other methods that require exposure to open flames, VOC based adhesives and/or high voltage electricity.

In one embodiment, the kit includes a fusion pipe with a first and second end, each end having outer pipe threads. Each end also can accept a strengthening collar. Preferably, the fusion pipe is of sufficient length so that the user may cut the pipe to a desired length and use both ends. The fusion pipe may have a central region with a uniform diameter. The fusion pipe may taper from a central region towards the ends. In another embodiment, the collars are fabricated from metal to generate the heat for the fusing operation.

### Incorporation by Reference

All patents, published patent applications and other references disclosed herein are hereby expressly incorporated in their entireties by reference.

While the invention has been described with respect to preferred embodiments, those skilled in the art will readily appreciate that various changes and/or modifications can be made to the invention without departing from the spirit or scope of the invention. For example, each claim may depend from any or all claims, even in a multiple dependent manner, even though such has not been originally claimed.

What is claimed is:

1. A fusion pipe assembly comprising:
a pipe having: a first end; and a second end with outer pipe threads, wherein the fusion pipe is fabricated completely from fusible material; and
a collar inserted in the second end and having an outer diameter approximately equal to an inner diameter of the second end so that the collar strengthens the second end.

2. A fusion pipe assembly as recited in claim 1, wherein the fusion pipe tapers from the first end to the second end and through the outer pipe threads.

3. A fusion pipe assembly as recited in claim 1, wherein an outer end of the collar forms a curved flange that abuts a tip of the second end to prevent the collar from passing too far into the fusion pipe.

4. A fusion pipe assembly as recited in claim 1, wherein the fusion pipe forms an inner shoulder near the second end, and an inner end of the collar abuts the inner shoulder to prevent the collar from passing too far into the fusion pipe.

5. A fusion pipe assembly as recited in claim 1, wherein the first end includes a fusion region.

6. A fusion pipe assembly as recited in claim 1,
wherein the first end has outer pipe threads, and
further comprising a second collar inserted in the first end, the second collar having an outer diameter approximately equal to an inner diameter of the second end so that the second collar strengthens the first end.

7. A fusion pipe assembly as recited in claim 6, wherein the collar and the second collar are fabricated from metal.

8. A fusion pipe assembly as recited in claim 6, wherein the fusion pipe tapers from a central region towards the first end and the second end.

9. A fusion pipe assembly as recited in claim 8, wherein the central region has a uniform diameter.

10. A fusion pipe assembly comprising:
a fitting having at least one open end with a fusion region;
a fusion pipe having: a proximal end with a fusion region; and a distal end for mechanically coupling in a pipe network, wherein the proximal end is inserted into the at least one open end and the fusion regions are fused together; and
a collar inserted in the distal end and having an outer diameter approximately equal to an inner diameter of the distal end so that the collar strengthens the distal end.

11. A fusion pipe assembly as recited in claim 10, wherein the fusion pipe is fabricated completely from fusible material.

12. A fusion pipe assembly as recited in claim 10, wherein the collar extends into the at least one open end of the fitting.

13. A fusion pipe assembly as recited in claim 10, wherein the fitting is a T-fitting.

14. A fusion pipe assembly as recited in claim 10, wherein an outer end of the collar forms a curved flange that abuts a tip of the distal end to prevent the collar from passing too far into the fusion pipe.

15. A fusion pipe assembly as recited in claim 10, wherein the fusion pipe forms an inner shoulder near the distal end, and an inner end of the collar abuts the inner shoulder to prevent the collar from passing too far into the fusion pipe.

16. A kit comprising:
a plurality of fittings, each fitting having at least one open end with a fusion region;
a plurality of fusion pipes, at least one of the pipes having: a proximal end with a fusion region; and a distal end for mechanically coupling in a pipe network; and
at least one collar for insertion in the distal end of the pipes, each collar having an outer diameter approximately equal to a respective inner diameter of the distal end so that the collar strengthens the distal end.

17. A kit as recited in claim 16, wherein the plurality of fittings, the plurality of fusion pipes are different types, sizes and lengths.

18. A kit as recited in claim 16, wherein the at least one collar is a plurality of collars of different types, sizes and lengths.

19. A kit as recited in claim 16, wherein the fusion pipes are fabricated from fusible material and the collars are fabricated from metal to provide heat during fusing.

20. A kit as recited in claim 11, further comprising a container for housing the fittings, fusion pipes and at least one collar.
